(19) United States
(12) Patent Application Publication
(10) Pub. No.: US 2007/0150664 A1
(43) Pub. Date: Jun. 28, 2007

(54) System and method for default data forwarding coherent caching agent

(76) Inventors: Chris Dombrowski, Cary, NC (US); Marcus Lathan Kornegay, Morrisville, NC (US); Ngan Ngoc Pham, Raleigh, NC (US)

Correspondence Address: IBM CORPORATION - RPS (JVL);C/O VAN LEEUWEN & VAN LEEUWEN, P.O. BOX 90609, AUSTIN, TX, 78709-0609, US

(21) Appl. No.: 11/320,075

(22) Filed: Dec. 28, 2005

(51) Int. Cl. G06F 13/28

(52) U.S. Cl. 711/144

(57) ABSTRACT

A system and method for default data forwarding coherent caching agent is present. A node controller receives a cache line request from either a local caching agent (local processor) or from a remote node controller. When a node controller receives a request from a local caching agent, the node controller sends the corresponding cache line to the local caching agent, all the while maintaining cache line forward state control. When the node controller receives a request from a remote node controller, the node controller sends the cache line, along with the cache line forward state control, to the remote node controller. In addition, the node controller performs particular actions based upon the source of the cache line request, the request type, and the cache line current status.

### BACKGROUND OF THE INVENTION

1. Technical Field

The present invention relates to a system and method for a default data forwarding coherent caching agent. More particularly, the present invention relates to a system and method for modifying a MESIF protocol's “Forward” state control in order to effectively support scaleable node controller computer systems.

2. Description of the Related Art

Cache coherency is an integral element of a computer system, which is the process of managing a cache so that data is not lost or overwritten. For example, when data is updated in a cache, but not yet transferred to its target memory or disk, the chance of corruption is high. Cache coherency is obtained using algorithms and protocols that keep track of the cache. In symmetric multiprocessing (SMP) systems, cache coherency is even more critical because multiple processors share the same memory space.

One existing cache coherency protocol is the MESIF (Modify, Exclusive, Shared, Invalid, Forward) protocol. When a cache line is in the “modified” state, a caching agent has the only correct data in the computer system. When a cache line is in the “exclusive” state (data has not been modified), the caching agent has exclusive control to modify the cache line. When a cache line is in the “shared” state, multiple caching agents may have the cache line in their cache memory to read, and each copy is correct. When the cache line at a caching agent is in the “invalid” state, the caching agent's copy is not correct because another processor has updated the corresponding memory position or has exclusive status of the cache line.

Finally, when a caching agent has cache line “forward” state control, the caching agent forwards the cache line to a requesting caching agent when it receives a cache line request. The forward state eliminates the need for the local caching agent to access main memory for the cache line, which improves overall system performance. A challenge found, however, is that the forward state is not optimized for systems using a scalable node controller. For these systems, the latency resulting from a cache access to a remote processor may be severe, depending upon the forward state management.

What is needed, therefore, is a system and method that effectively manages the MESIF protocol's cache line forward state control for systems using a scalable node controller.

### SUMMARY

It has been discovered that the aforementioned challenges are resolved using a system and method for permitting only node controllers to possess cache line forward state control in the MESIF protocol. When a node controller receives a request from a local caching agent, the node controller sends the corresponding cache line to the local caching agent, all the while maintaining cache line forward state control. When the node controller receives a request from a remote node controller, the node controller sends the cache line, along with the cache line forward state control, to the remote node controller.

A node controller receives a cache line request from either a local caching agent (local processor) or from a remote node controller. The node controller performs particular actions based upon the source of the cache line request, the request type, and the cache line current status. When the node controller receives a shared request from a local caching agent and the corresponding cache line's current status is shared, the node controller simply sends the cache line to the local caching agent. For example, two processors may be sharing (e.g., reading) a particular cache line, and a third processor wishes to read the same cache line.

When the node controller receives a shared request from a local caching agent and the corresponding cache line's current status is exclusive, the node controller first notifies the controlling agent, which is the caching agent that has the cache line in an exclusive state, to downgrade its status to “shared.” The node controller then sends the cache line to the local caching agent and, in turn, updates its log that the cache line is in a shared state.

When the node controller receives an exclusive request from a local caching agent, it is somewhat immaterial as to the cache line's current status because the node controller notifies sharing caching agents, as well as controlling agents, to downgrade their status to “invalid” because the local caching agent requests exclusive access. Once the notification is sent, the node controller sends the cache line to the local caching agent and, in turn, updates its log to identify the local caching agent as the controlling agent of the cache line.

When the node controller receives a remote shared request from a remote node controller and the cache line's current status is shared, the node controller sends the cache line and the cache line forward state control to the remote node controller. In turn, the node controller updates its log to identify that the remote node controller now has cache line forward state control for the particular cache line.

When the node controller receives a remote shared request from a remote node controller and the corresponding cache line's current status is exclusive, the node controller first notifies the controlling agent to downgrade its status to shared. The node controller then sends the cache line and the cache line forward state control to the remote node controller. In turn, the node controller updates its log to identify that the remote node controller now has cache line forward state control for the particular cache line.

Finally, when the node controller receives a remote exclusive request from a remote node controller, it is somewhat immaterial as to the cache line's current status. The node controller first notifies sharing caching agents as well as controlling agents to downgrade their status to “invalid.” Once the notification is sent, the node controller sends the cache line and the cache line forward state control to the remote node controller. In turn, the node controller updates its log to identify that the remote node controller now has forward state control for the particular cache line.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing a processor or a node controller forwarding a cache line forward state control to a remote node processor without the invention described herein;

FIG. 2 is a diagram showing a node controller forwarding a cache line and a cache line forward state control to a remote node controller;

FIG. 3 is a table showing node controller action based upon a cache line request type and the cache line current status;

FIG. 4 is a flowchart showing steps taken in a processor requesting a cache line and receiving the cache line from a node controller;

FIG. 5 is a high level flowchart showing steps taken in a node controller processing a cache line request;

FIG. 6 is a flowchart showing steps taken in processing a remote cache line request; and

FIG. 7 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

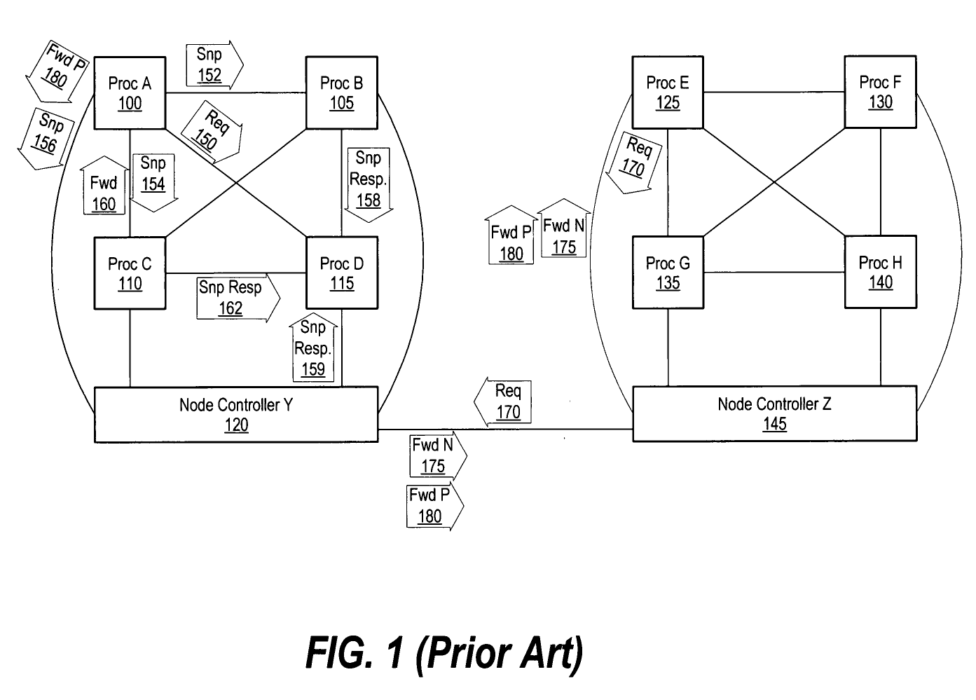

FIG. 1 is a diagram showing a computer system abiding by an existing MESIF (Modify, Exclusive, Shared, Invalid, Forward) protocol without the invention described herein. Each processor and node controller shown in FIG. 1 includes a caching agent, which requests and receives cache lines. The processors access a memory map in order to determine the “home node” of a particular cache line, which is the physical location of the cache line.

The example in FIG. 1 starts with processor A 100 requesting a cache line for read purposes only. Processor A 100 determines that processor D 115 is the home node of the particular cache line, and sends request 150 to processor D 115. In addition, processor A 100 sends “snoops” 152, 154, and 156 to processor B 105, processor C 110, and node controller Y 120, respectively. Snoops are requests to other local caching agents that are not the home node to handle situations when caching agents other than the home node caching agent have control of the requested cache line (see below).

In the example shown in FIG. 1, processor C 110 has control of the particular cache line, and also has “cache line forward state control” (based upon the existing MESIF protocol). The caching agent that has cache line forward state control is responsible for forwarding the cache line to a local caching agent. As such, processor C 110 forwards the cache line, as well as the cache line forward state control, to processor A 100 (forward 160). In addition, processor C 110 sends snoop response 162 to processor D 115 (home node) indicating its actions. Processor B 105, processor C 110, and node controller Y 120 also send snoop responses 158, 162, and 159, to processor D 115, respectively.

Continuing with the example in FIG. 1, processor E 125 (remote processor) now requests to read the same cache line. As such, processor E 125 sends request 170 to node controller Z 145, which sends request 170 to node controller Y 120. At this point, the existing art allows two alternatives for providing processor E 125 with the cache line.

The first alternative has node controller Y sending the cache line, along with the cache line forward state control, to processor E 125 (forward N 175). The disadvantage with this alternative is the complex management of the cache line forward state control, which may result in processor A 100 and processor E 125 having cache line forward state control at the same time.

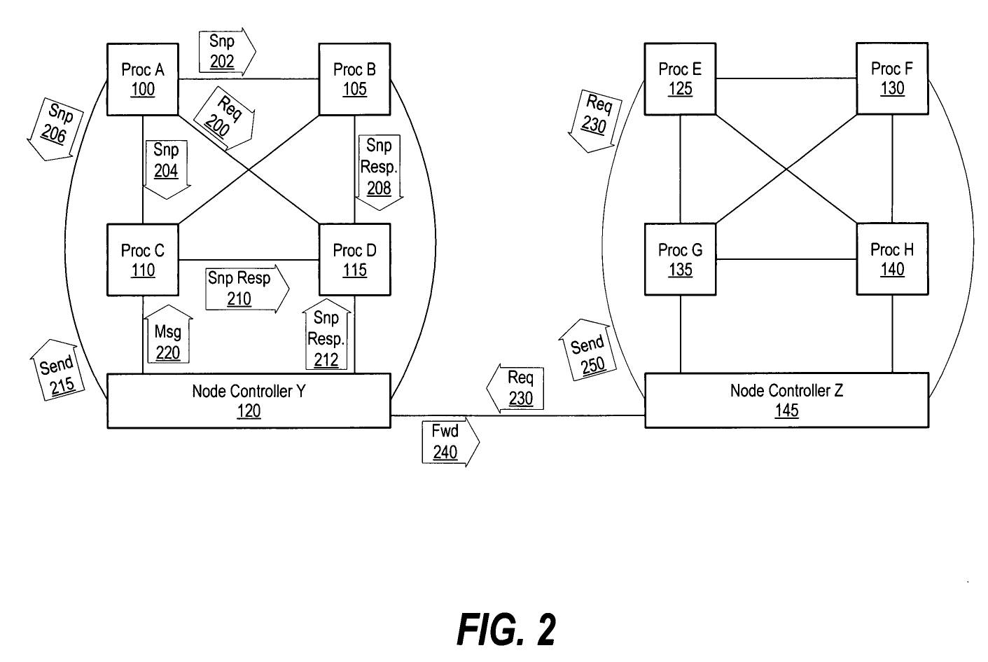

The second alternative has processor A 100 sending the cache line, along with the cache line forward state control, to processor E 125 through node controller Y 120 (forward P 180). The disadvantage with this alternative is that there is a significant increase in data latency, which degrades overall system performance. Therefore, by altering the MESIF protocol to have only node controllers possesses cache line forward state control using the invention described herein, system complexity and system latency is reduced (see FIGS. 2-6 and corresponding text for further details).

FIG. 2 is a diagram showing a computer system abiding by a modified MESIF protocol using the invention described herein. The modified MESIF protocol allows only node controllers to possess cache line forward state control. As a result, a node controller sends cache lines to local caching agents, while still maintaining cache line forward state control. When the node controller receives a request from a remote node controller, the node controller sends the cache line and the cache line forward state control to the remote node controller. Processors A 100, B 105, C 110, D 115, and node controllers Y 120 and Z 145 are the same as that shown in FIG. 1.

The example in FIG. 2 starts similar to FIG. 1 with processor A 100 requesting a cache line “shared request” (read purposes only). Processor A 100 determines that processor D 115 is the home node of the particular cache line, and sends request 200 to processor D 115. In addition, processor A 100 sends “snoops” 202, 204, and 206 to processor B 105, processor C 110, and node controller Y 120, respectively.

In one embodiment, a shared request is a “Bus Read Line” (BRL) request. In this embodiment, the caching agent does not know if the cache line is shared, exclusive, invalid, enterprise tier component. If the cache line is in use at another processor or node controller, the requesting agent caches the line in shared state as a result of the BRL request.

In the example shown in FIG. 2, processor C 110 has control of the cache line (exclusive state) requested by processor A 100. However, using the invention described herein, processor C 110 does not have cache line forward state control. Rather, node controller Y 120 has cache line forward state control. Processor B 105, processor C 110, and node controller Y 120 send snoop responses 208, 210, and 212, to processor D 115, respectively.

As a result of node controller Y 120 having cache line forward state control, node controller Y 120 sends message 220 to processor C 110, which instructs processor C 110 to downgrade its status to a shared state. In turn, node controller Y 120 sends the cache line (send 215) to processor A 100, all the while maintaining cache line forward state control.

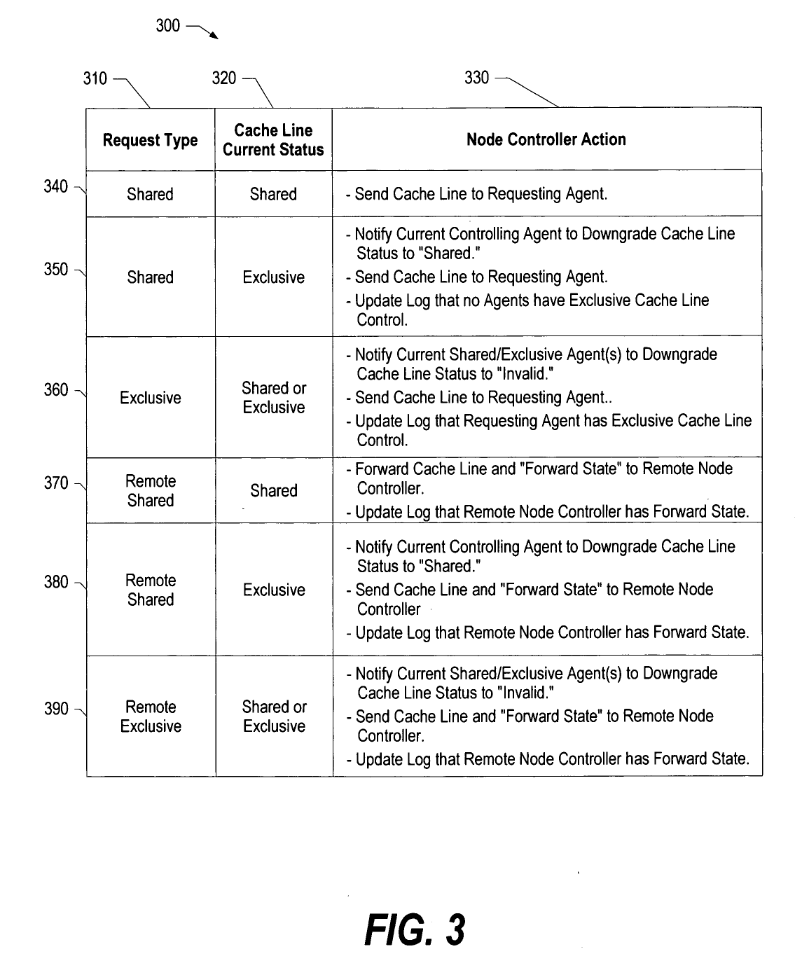

Continuing with the example in FIG. 2, processor E 125 (remote processor) now requests to read the same cache line. As such, processor E 125 sends request 230 to node controller Z 145, which sends request 230 to node controller Y 120. Since node controller Y 120 has cache line forward state control, node controller Y 120 sends the cache line, along with the cache line forward state control to node controller Z 145 (forward 240). Prior to sending forward 240, node controller Y 120 may send a message to one or more local processors (processor A 100, processor B 105, processor C 110, and processor D 115) notifying them to downgrade their status. The message is based upon the cache line's current status and the request “type” of request 230 (shared or exclusive) (see FIG. 3 and corresponding text for further details regarding status downgrading).

Once node controller Z 145 receives the cache line and the cache line forward state control, node controller Z 145 retains the cache line forward state control and sends the cache line (send 250) to processor E 125. As a result, only node controllers Y 120 and Z 145 have possession of the cache line forward state control.

FIG. 3 is a table showing node controller action based upon a cache line request type and the cache line current status. The cache line request type may be a local request, such as from a processor that the node controller supports, or the cache line may be a remote request, such as from a remote node controller. The cache line current status may be a “shared” status if one or more caching agents are reading a cache line, or the cache line current status may be “exclusive” if one of the caching agents has the cache line in an exclusive state and intends to modify the cache line, but has not yet modified the cache line.

In one embodiment, an exclusive request is a “Bus Read Invalidate Line” (BRIL) request. In this embodiment, the caching agent does not know if the cache line is currently shared, exclusive, invalid, etc. When a caching agent requests to read a cache line with intent to modify the contents of the cache line (BRIL request), the state of the cache line is downgraded to “invalid” at other caching agents that are currently using the cache line.

Table 300 includes columns 310 through 330. Column 310 includes various request types that a node controller receives from a local caching agent or a remote node controller. Column 320 includes “shared” or “exclusive” cache line current status identifiers and column 330 includes actions that the node controller performs based upon the request type in column 310 and the cache line current status in column 320.

Lines 340 through 360 show actions taken when a node controller receives a cache line request from a local caching agent. Line 340 shows that by receiving a shared request from a local caching agent and the corresponding cache line's current status is shared, the node controller simply sends the cache line to the local caching agent. For example, two processors may be sharing (e.g., reading) a particular cache line, and a third processor wishes to read the same cache line.

Line 350 shows that when the node controller receives a shared request from a local caching agent and the corresponding cache line's current status is exclusive, the node controller first notifies the controlling agent, which is the caching agent that has the cache line in an exclusive state, to downgrade its status to “shared.” The node controller then sends the cache line to the local caching agent and, in turn, the node controller updates its log that the cache line is in a shared state.

Line 360 shows that when the node controller receives an exclusive request type, it is somewhat immaterial as to the cache line's current status because the node controller notifies sharing caching agents as well as controlling agents to downgrade their status to invalid because the local caching agent is requesting exclusive access. Once the notification is sent, the node controller sends the cache line to the local caching agent and, in turn, the node controller updates its log to identify the local caching agent as the controlling agent of the cache line.

Lines 370 through 390 show actions taken when a node controller receives a request from a remote node controller. Line 370 shows that when the node controller receives a remote shared request and the cache line's current status is shared, the node controller sends the cache line and the cache line forward state control to the remote node controller. In turn, the node controller updates its log to identify that the remote node controller now has cache line forward state control for the particular cache line.

Line 380 shows that when the node controller receives a remote shared request and the corresponding cache line's current status is exclusive, the node controller first notifies the controlling agent to downgrade its status to shared. The node controller then sends the cache line and the cache line forward state control to the remote node controller. In turn, the node controller updates its log to identify that the remote node controller now has cache line forward state control for the particular cache line.

Line 390 shows that when the node controller receives a remote exclusive request type, it is somewhat immaterial as to the cache line's current status, such as that shown in line 360. The node controller first notifies sharing caching agents as well as controlling agents to downgrade their status to invalid. Once the notification is sent, the node controller sends the cache line and the cache line forward state control to the remote node controller. In turn, the node controller updates its log to identify that the remote node controller now has forward state control for the particular cache line.

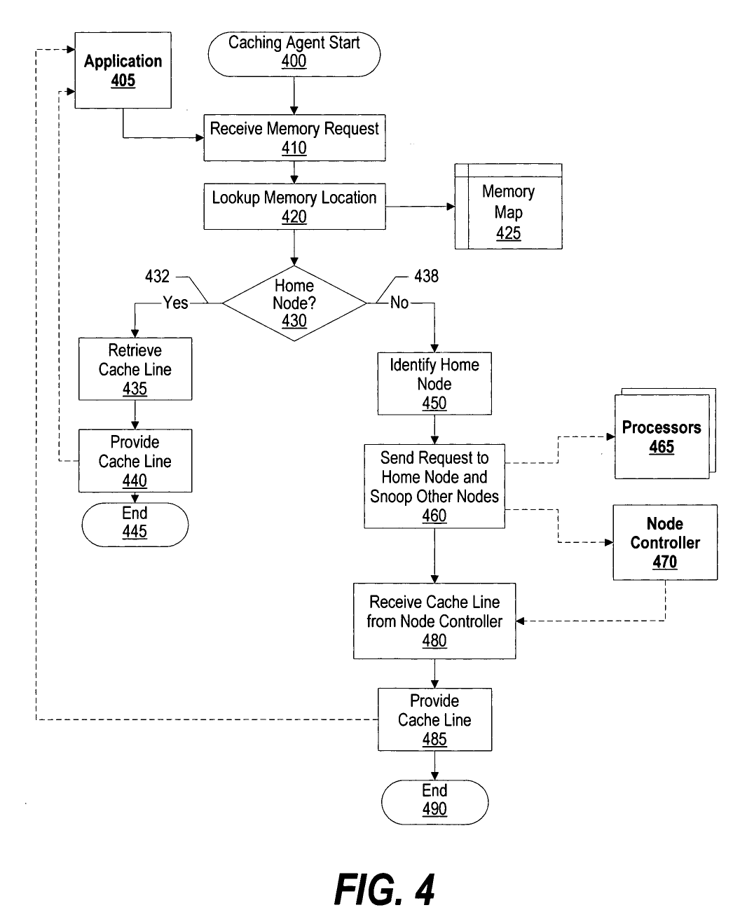

FIG. 4 is a flowchart showing steps taken in a caching agent requesting a cache line and receiving the cache line from a node controller. A caching agent is included in a processor, which handles cache line requests, such as from an application. The cache line request may correspond to an internal cache line (internal to the processor) or an external cache line (external to the processor).

Caching agent processing commences at 400, whereupon the caching agent receives a memory request from application 405 at step 410. For example, application 405 may be computing a numerical value and require a number that is stored in a particular cache line. At step 420, the caching agent looks up the memory location in memory map 425 to identify the cache line's “home node,” which is the physical processor location of the cache line. Memory map 425 may be stored on a volatile storage area, such as computer memory.

A determination is made as to whether the processor itself is the home node (decision 430). If the processor itself is the home node, decision 430 branches to “Yes” branch 432 whereupon the caching agent retrieves the cache line from local memory (step 435) and provides the cache line to application 405 at step 440. Caching agent processing ends at 445.

On the other hand, if the requested cache line's home node is at a different processor, decision 430 branches to “No” branch 438 whereupon the caching agent identifies the corresponding cache line's home node based upon the identified memory map location above (step 450). For example, in a four-processor system, the caching agent may identify that the cache line's home node is at the third processor.

At step 460, the caching agent sends a request to the home node processor (included in processors 465), and sends “snoops” to the other processors in processors 465 as well as node controller 470. Node controller 470 is a local node controller that controls cache line forwarding. At step 480, the caching agent receives the requested cache line from node controller 470 and provides the cache line to application 405 at step 485. Processing ends at 490.

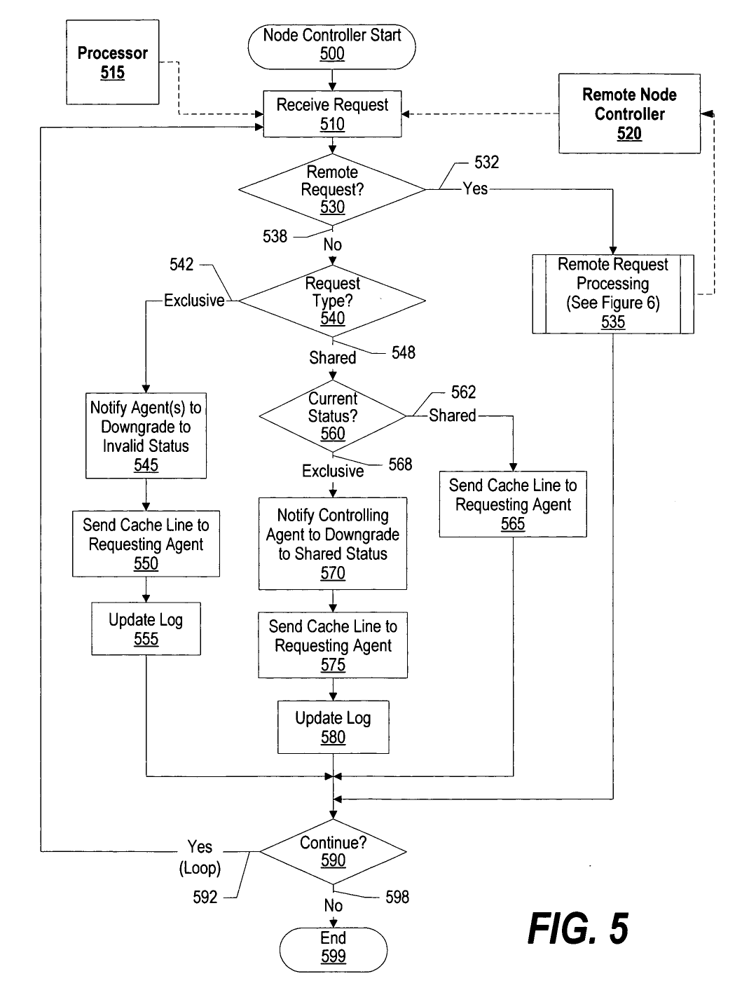

FIG. 5 is a high level flowchart showing steps taken in a node controller processing a cache line request. Node controller processing commences at 500, whereupon the node controller receives a cache line request from either a local caching agent included in processor 515 or from remote node controller 520.

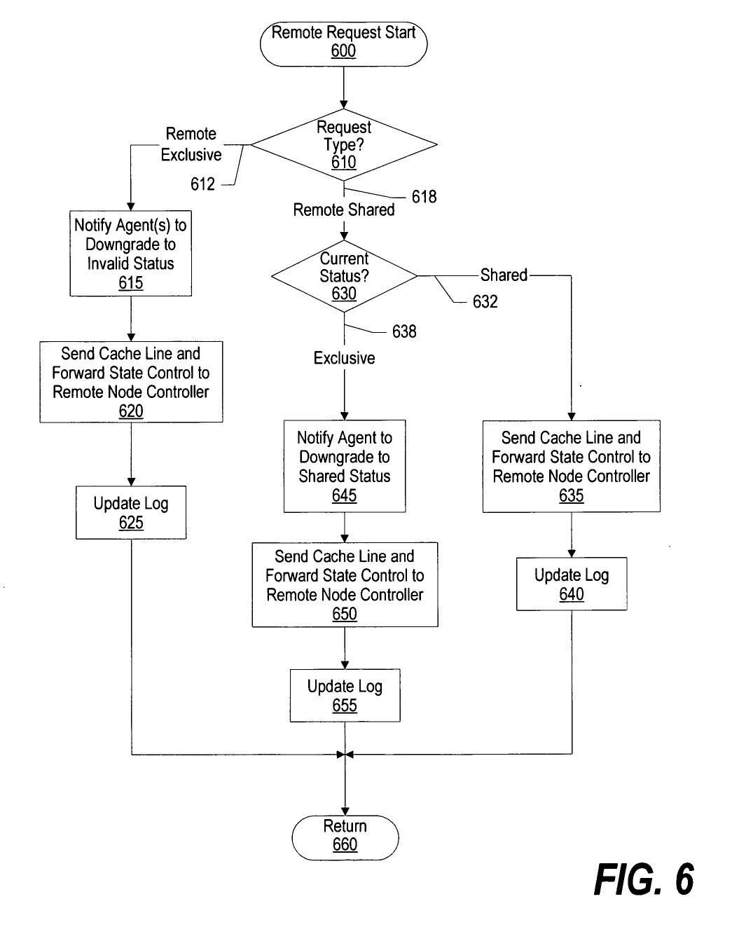

A determination is made as to whether the cache line request is from processor 515 (local request) or from remote node controller (remote request) (decision 530). If the cache line request is a remote request, decision 530 branches to “Yes” branch 532 whereupon the node controller processes the remote request (pre-defined process block 535, see FIG. 6 and corresponding text for further details).

On the other hand, if the cache line request is a local request, decision 530 branches to “No” branch 538 whereupon a determination is made as to the cache line request's “request type.” The request type may be a “shared” request (read only) or the request type may be an “exclusive” request (intend to modify) (decision 540). If the request is an exclusive request, decision 540 branches to “Exclusive” branch 542 whereupon processing notifies other agents that have the corresponding cache line in a shared state or exclusive state to downgrade their status to an “invalid” state because the local caching agent is requesting exclusive status to the corresponding cache line (step 545).

At step 550, the node controller sends the cache line to the local caching agent, all the while maintaining “forward state control” of the cache line. Meaning, even though the node controller sends the cache line to the local caching agent, the next time that a caching agent requests the same cache line, the node controller is still responsible for sending the cache line to the other caching agent. At step 555, the node controller updates a log that identifies the local caching agent as the new controlling agent (due to the exclusive cache line request).

On the other hand, if the cache line request is a shared request (read only), decision 540 branches to “Shared” branch 548 whereupon a determination is made as to the corresponding cache line's current status, which may be shared or exclusive (decision 560). If the cache line current status is “shared,” decision 560 branches to “Shared” branch 562 whereupon the node controller sends the cache line to the local caching agent in processor 515 at step 565. Again, the node controller maintains forward state controller.

On the other hand, if the cache line current status is exclusive, decision 560 branches to “Exclusive” branch 568 whereupon the node controller notifies a controlling agent (the agent that currently has exclusive status of the cache line) to downgrade its status to “shared” at step 570. At step 575 the node controller forwards the cache line to the local caching agent located in processor 515. The node controller logs, at step 580, that no caching agents are currently a controlling agent.

A determination is made as to whether to continue node controller processing (decision 590). If the node controller should continue processing cache line requests, decision 590 branches to “Yes” branch 592, which loops back to process another cache line request. This looping continues until the node controller should terminate, at which point decision 590 branches to “No” branch 598 whereupon processing ends at 599.

FIG. 6 is a flowchart showing steps taken in processing a remote cache line request. The steps in FIG. 6 are similar to the steps in FIG. 5 with the exception that a node controller forwards a cache line's “forward state control” to a remote node controller as well as the cache line itself. Processing commences at 600, whereupon a determination is made as to the remote node controller's request type (decision 610). If the request is a remote exclusive request, decision 610 branches to “Remote Exclusive” branch 612 whereupon processing notifies other agents that have the corresponding cache line in a shared state or exclusive state to downgrade their status to an invalid state because the local caching agent is requesting exclusive status to the corresponding cache line (step 615).

At step 620, the node controller sends the cache line and the forward state control to the remote node controller. As a result, the remote node controller is now responsible for handling subsequent requests for the particular cache line. At step 625, the node controller updates its log that identifies the remote node controller having forward state control of the cache line.

On the other hand, if the cache line request is a shared request (read only), decision 610 branches to “Remote Shared” branch 618 whereupon a determination is made as to the corresponding cache line's current status, which may be shared or exclusive (decision 630). If the cache line current status is “shared,” decision 630 branches to “Shared” branch 632 whereupon the node controller sends the cache line and the forward state control to the remote node controller at step 635. At step 640, the node controller updates its log that identifies the remote node controller having forward state control of the cache line.

On the other hand, if the cache line current status is exclusive, decision 630 branches to “Exclusive” branch 638 whereupon the node controller notifies a controlling agent (the agent that currently has exclusive status of the cache line) to downgrade its status to “shared” at step 645. At step 650, the node controller sends the cache line and the forward state control to the remote node controller. The node controller logs, at step 655, that no caching agents are a controlling agent (exclusive control) and that the remote node controller has forward state control of the cache line. Processing returns at 660.

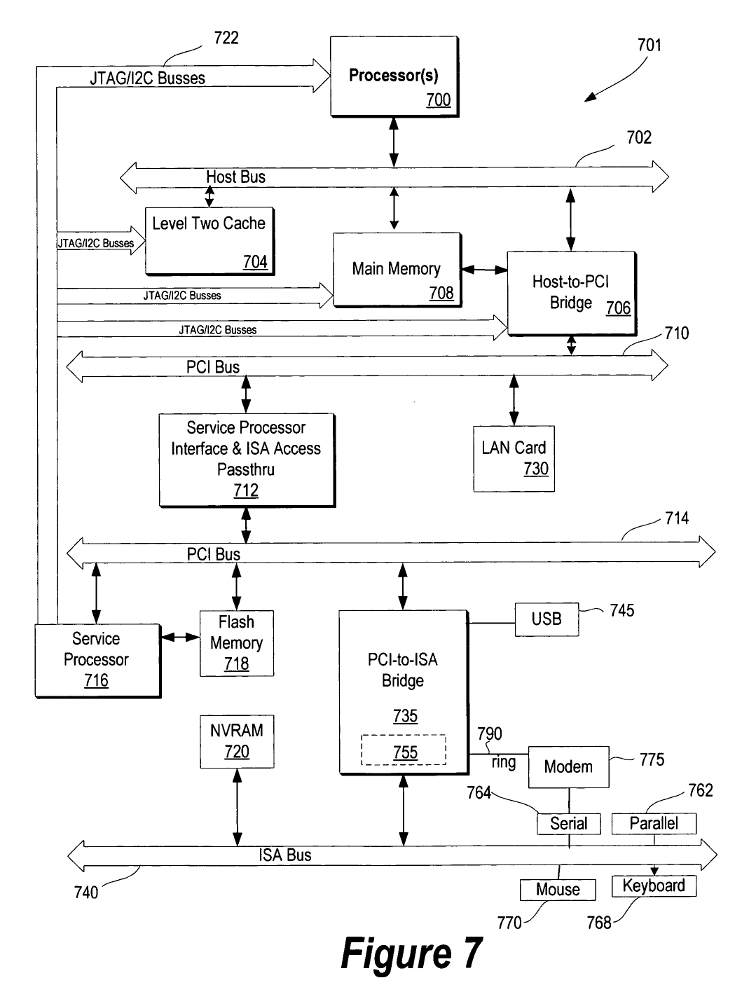

FIG. 7 illustrates information handling system 701, which is a simplified example of a computer system capable of performing the computing operations described herein. Computer system 701 includes processor 700, which is coupled to host bus 702. A level two (L2) cache memory 704 is also coupled to host bus 702. Host-to-PCI bridge 706 is coupled to main memory 708, includes cache memory and main memory control functions, and provides bus control to handle transfers among PCI bus 710, processor 700, L2 cache 704, main memory 708, and host bus 702. Main memory 708 is coupled to Host-to-PCI bridge 706 as well as host bus 702. Devices used solely by host processor(s) 700, such as LAN card 730, are coupled to PCI bus 710. Service Processor Interface and ISA Access Pass-through 712 provides an interface between PCI bus 710 and PCI bus 714. In this manner, PCI bus 714 is insulated from PCI bus 710. Devices, such as flash memory 718, are coupled to PCI bus 714. In one implementation, flash memory 718 includes BIOS code that incorporates the necessary processor executable code for a variety of low-level system functions and system boot functions.

PCI bus 714 provides an interface for a variety of devices that are shared by host processor(s) 700 and Service Processor 716 including, for example, flash memory 718. PCI-to-ISA bridge 735 provides bus control to handle transfers between PCI bus 714 and ISA bus 740, universal serial bus (USB) functionality 745, power management functionality 755, and can include other functional elements not shown, such as a real-time clock (RTC), DMA control, interrupt support, and system management bus support. Nonvolatile RAM 720 is attached to ISA Bus 740. Service Processor 716 includes JTAG and I2C busses 722 for communication with processor(s) 700 during initialization steps. JTAG/I2C busses 722 are also coupled to L2 cache 704, Host-to-PCI bridge 706, and main memory 708 providing a communications path between the processor, the Service Processor, the L2 cache, the Host-to-PCI bridge, and the main memory. Service Processor 716 also has access to system power resources for powering down information handling device 701.

Peripheral devices and input/output (I/O) devices can be attached to various interfaces (e.g., parallel interface 762, serial interface 764, keyboard interface 768, and mouse interface 770 coupled to ISA bus 740. Alternatively, many I/O devices can be accommodated by a super I/O controller (not shown) attached to ISA bus 740.

In order to attach computer system 701 to another computer system to copy files over a network, LAN card 730 is coupled to PCI bus 710. Similarly, to connect computer system 701 to an ISP to connect to the Internet using a telephone line connection, modem 775 is connected to serial port 764 and PCI-to-ISA Bridge 735.

While FIG. 7 shows one information handling system that employs processor(s) 700, the information handling system may take many forms. For example, information handling system 701 may take the form of a desktop, server, portable, laptop, notebook, or other form factor computer or data processing system. Information handling system 701 may also take other form factors such as a personal digital assistant (PDA), a gaming device, ATM machine, a portable telephone device, a communication device or other devices that include a processor and memory.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
detecting, at a node controller, a cache line request;
determining, at the node controller, whether the cache line request corresponds to a local caching agent; and
in response to determining that the cache line request corresponds to the local caching agent, forwarding a cache line to the local caching agent while retaining a cache line forward state control at the node controller, the cache line corresponding to the cache line request and the cache line forward state control corresponding to the cache line.

2. The method of claim 1 further comprising:
determining that the cache line request corresponds to a remote node controller; and
in response to determining that the cache line request corresponds to the remote node controller, forwarding the cache line and the cache line forward state control to the remote node controller.

3. The method of claim 2 wherein the cache line request corresponds to the remote node controller, the method further comprising:
determining that the cache line request is remote shared request;
determining that a cache line current status corresponding to the cache line is exclusive; and
in response to determining that the cache line request is a remote shared request and determining that the cache line current status is exclusive:
notifying a controlling agent to downgrade its status to shared, the controlling agent associated with the exclusive cache line status; and
in response to the notifying, updating a log that the remote node controller has the cache line forward state control for the cache line.

4. The method of claim 2 wherein the cache line request corresponds to the remote node controller, the method further comprising:
determining that the cache line request is remote exclusive request;
determining that a cache line current status corresponding to the cache line is exclusive; and
in response to determining that the cache line request is a remote exclusive request and determining that the cache line current status is exclusive:
notifying one or more other local caching agents to downgrade their status to invalid; and
in response to the notifying, updating a log that the remote node controller has the cache line forward state control for the cache line.

5. The method of claim 1 further comprising:
determining that the cache line request is a shared request;
determining that a cache line current status corresponding to the cache line is exclusive; and
in response to determining that the cache line request is a shared request and determining that the cache line current status is exclusive:
notifying a controlling agent to downgrade its status to shared, the controlling agent associated with the exclusive cache line status; and
in response to the notifying, updating a log that the controlling agent no longer has exclusive cache line status for the cache line.

6. The method of claim 1 further comprising: determining that the cache line request is an exclusive request;
determining that a cache line current status corresponding to the cache line is exclusive; and
in response to determining that the cache line request is an exclusive request and determining that the cache line current status is exclusive:
notifying a controlling agent to downgrade its status to invalid, the controlling agent associated with the exclusive cache line status; and
in response to the notifying, updating a log that the local agent has exclusive cache line status for the cache line.

7. The method of claim 1 wherein the cache line request is selected from the group consisting of a bus read line request and a bus read invalidate request.

8. A computer program product stored on a computer operable media, the computer operable media containing instructions for execution by a computer, which, when executed by the computer, cause the computer to implement a method for managing a cache line forward state control, the method comprising:
detecting, at a node controller, a cache line request;
determining, at the node controller, whether the cache line request corresponds to a local caching agent; and
in response to determining that the cache line request corresponds to the local caching agent, forwarding a cache line to the local caching agent while retaining a cache line forward state control at the node controller, the cache line corresponding to the cache line request and the cache line forward state control corresponding to the cache line.

9. The computer program of claim 8 wherein the method further comprises:
determining that the cache line request corresponds to a remote node controller; and
in response to determining that the cache line request corresponds to the remote node controller, forwarding the cache line and the cache line forward state control to the remote node controller.

10. The computer program of claim 9 wherein the cache line request corresponds to the remote node controller, the method further comprising:
determining that the cache line request is remote shared request;
determining that a cache line current status corresponding to the cache line is exclusive; and
in response to determining that the cache line request is a remote shared request and determining that the cache line current status is exclusive:
notifying a controlling agent to downgrade its status to shared, the controlling agent associated with the exclusive cache line status; and
in response to the notifying, updating a log that the remote node controller has the cache line forward state control for the cache line.

11. The computer program of claim 9 wherein the cache line request corresponds to the remote node controller, the method further comprising:
determining that the cache line request is remote exclusive request;
determining that a cache line current status corresponding to the cache line is exclusive; and
in response to determining that the cache line request is a remote exclusive request and determining that the cache line current status is exclusive:
notifying one or more other local caching agents to downgrade their status to invalid; and
in response to the notifying, updating a log that the remote node controller has the cache line forward state control for the cache line.

12. The computer program of claim 8 wherein the method further comprises:
determining that the cache line request is a shared request;
determining that a cache line current status corresponding to the cache line is exclusive; and
in response to determining that the cache line request is a shared request and determining that the cache line current status is exclusive:
notifying a controlling agent to downgrade its status to shared, the controlling agent associated with the exclusive cache line status; and
in response to the notifying, updating a log that the controlling agent no longer has exclusive cache line status for the cache line.

13. The computer program of claim 8 wherein the method further comprises:
determining that the cache line request is an exclusive request;
determining that a cache line current status corresponding to the cache line is exclusive; and
in response to determining that the cache line request is an exclusive request and determining that the cache line current status is exclusive:
notifying a controlling agent to downgrade its status to invalid, the controlling agent associated with the exclusive cache line status; and
in response to the notifying, updating a log that the local agent has exclusive cache line status for the cache line.

14. The computer program of claim 8 wherein the cache line request is selected from the group consisting of a bus read line request and a bus read invalidate request.

15. An information handling system comprising:
one or more processors;
a memory accessible by the processors;
one or more nonvolatile storage devices accessible by the processors; and
a cache line management tool for managing cache line forward state control, the cache line management tool being effective to:
detect, at a node controller, a cache line request received over a computer network;
determine, at the node controller, whether the cache line request corresponds to a local caching agent; and
in response to determining that the cache line request corresponds to the local caching agent, forward a cache line to the local caching agent over the computer network while retaining a cache line forward state control at the node controller, the cache line corresponding to the cache line request and the cache line forward state control corresponding to the cache line.

16. The information handling system of claim 15 wherein the cache line management tool is further effective to:
determine that the cache line request corresponds to a remote node controller; and
in response to determining that the cache line request corresponds to the remote node controller, forward the cache line and the cache line forward state control to the remote node controller over the computer network.

17. The information handling system of claim 16 wherein the cache line request corresponds to the remote node controller, the cache line management tool further effective to:
determine that the cache line request is remote shared request;
determine that a cache line current status corresponding to the cache line is exclusive; and
in response to determining that the cache line request is a remote shared request and determining that the cache line current status is exclusive:
notify a controlling agent over the computer network to downgrade its status to shared over the computer network, the controlling agent associated with the exclusive cache line status; and
in response to the notifying, update a log located in one of the nonvolatile storage devices that the remote node controller has the cache line forward state control for the cache line.

18. The information handling system of claim 16 wherein the cache line request corresponds to the remote node controller, the cache line management tool further effective to:
determine that the cache line request is remote exclusive request;
determine that a cache line current status corresponding to the cache line is exclusive; and
in response to determining that the cache line request is a remote exclusive request and determining that the cache line current status is exclusive:
notify one or more other local caching agents over the computer network to downgrade their status to invalid; and
in response to the notifying, update a log included in one of the nonvolatile storage devices that the remote node controller has the cache line forward state control for the cache line.

19. The information handling system of claim 15 wherein the cache line management tool is further effective to:
determine that the cache line request is a shared request;
determine that a cache line current status corresponding to the cache line is exclusive; and
in response to determining that the cache line request is a shared request and determining that the cache line current status is exclusive:
notify a controlling agent over the computer network to downgrade its status to shared, the controlling agent associated with the exclusive cache line status; and
in response to the notifying, update a log located in one of the nonvolatile storage devices that the controlling agent no longer has exclusive cache line status for the cache line.

20. The information handling system of claim 15 wherein the cache line management tool is further effective to:
determine that the cache line request is an exclusive request;
determine that a cache line current status corresponding to the cache line is exclusive; and
in response to determining that the cache line request is an exclusive request and determining that the cache line current status is exclusive:
notify a controlling agent over the computer network to downgrade its status to invalid, the controlling agent associated with the exclusive cache line status; and
in response to the notifying, update a log located on one of the nonvolatile storage devices that the local agent has exclusive cache line status for the cache line.
